(19) United States
(12) Patent Application Publication
(10) Pub. No.: US 2005/0083412 A1
(43) Pub. Date: Apr. 21, 2005

(54) Internet interactive realtime video image acquisition system based in low earth orbit

(76) Inventor: Scott Damian Murphy, West Friendship, MD (US)

Correspondence Address: Scott D. Murphy, 3272 Rosemary Lane, West Friendship, MD, 21794, US

(21) Appl. No.: 10/690,153

(22) Filed: Oct. 21, 2003

(51) Int. Cl. H04N 7/18; H04N 9/47; H04N 7/20

(52) U.S. Cl. 348/211.2; 348/144; 348/211.4; 725/67

(57) ABSTRACT

A system, method, and apparatus for obtaining and distributing live and real-time video imagery of the Earth, Earth's local space environment, the Moon, celestial bodies and any events or objects that are visible to a Low Earth Orbiting space based video imaging system that is interactively controlled by any operator using an internet connected computer. A LEO spacecraft serves as the platform for the suite of multiaxis controlled video image sensors. The spacecraft's communication system provides the high data rate downlink (and lower rate uplink) through one or several or multiplexed S- or X-band transceivers. The tranceiver(s) broadcast the video stream down to one or more remote transceiving stations sited around the world. The tranceiving stations are directly connected to the internet and provide live real-time streaming of the downlinked imagery data. The internet connected remote ground stations also provide a real-time interactive control environment (less than 3 seconds for interactive loop) whereby any operator who is authorized can actively control one or more of the onboard video image sensors.

### BACKGROUND OF THE INVENTION

The fields of endeavor to which this invention generally pertains to are space based remote sensing and internet interactive media content. The invention described herein seeks to combine these fields via a system, method and apparatus that performs space based remote sensing while being interactively controlled and delivering live video media content through the internet infrastructure.

Space based remote sensing has evolved over the past 30+ years to where it has become common to see and use the imagery generated by satellites for studying weather and the atmosphere, analyzing land regions for agriculture, monitoring the oceans and even surveillance of large scale human activity on Earth. In order to satisfy the requirements of the science and commercial sectors it has been the focus of the remote sensing industry to develop the highest resolution images while working toward decreasing the time between images of the same location or event.

Technical achievements in the instrumentation on board these satellites have trended toward higher and more spectrally diverse resolution for monitoring features on an ever smaller scale. This has been accomplished by the use of digital image sensors (such as Charged Coupled Devices or CCDs) that are increasingly pixelated and are coupled to optics systems of increasing cost and complexity. These sensing systems generate high resolution images that can then be used to develop specific data products for varied customers who are interested in studying Earth surface or atmospheric features in great detail. In order to get these high resolution images the sensors require longer integration times where light gathering and data processing can increase the information that is inherent in the captured image. NOAA/NASA GOES-series spacecraft has used complicated methods of moving light gathering mirrors to direct image light to focal plane pixels that are in a line. The mirrors scan a narrow band of the view that in turn is captured by the pixels. This is repeated over 1300 times (at about a line a second) to generate a full field image. This takes over 20 minutes to generate the full field image. As is demonstrated here, while the images are of very high spatial quality, this type of system will not produce realtime data that can capture dynamic events that have time scales of minutes or seconds.

Recently there have been some attempts at reducing the time between successive images in order to monitor the temporal evolution of dynamic activity such as weather patterns or human activity. There is an system concept by Astrovision International (reference U.S. Pat. No. 6,504,570) that seeks to string together a series of digital snapshots that are taken a couple of minutes apart to create a time evolving sequence for events viewed from Geostationary Orbit (GEO). The essence of this system is to place a GEO satellite above a given point on the Earth and, using fixed high resolution image sensors, monitor the Earth and then send down the captured images which would be analyzed for changes from one image to the next.

Another problem with trying to obtain these high resolution images is that these sensing instruments require stable backgrounds in order to reduce pixel or image blur which degrades resolution. The desire to capture features on a small spatial scale requires the use of a stable platform (such as a GEO satellite) that have complex automated spacecraft attitude control systems in order to reduce pixel blur that occurs when the sensor platform moves while capturing the image. There has been a lot of effort in developing ultra-stable spacecraft platforms that employ sophisticated 3 axis attitude control systems. The GOES spacecraft are using 3 axis stabilization that are very precise and afford a very stable platform from which to monitor the Earth. This stability requirement along with the high resolution requirement drives the cost and complexity up to points where only governments can afford to build and operate them.

There has been a lot of activity over the last 10 years in developing small satellites and satellite constellations (two or more satellites providing increased Earth coverage). Small satellites provide a lower cost means to deploy and operate science instrumentation and communications systems in space. In fact the costs associated with building a small satellite is lower by a factor often from what is was in the early 1990s. The advent of small satellite constellations is driven by the desire to get larger scale coverage of the Earth and reduce the time between successive monitoring of a particular place on the Earth's surface. These satellites typically have either fixed image sensors or automated scanning sensors that “sweep” back and forth in order to increase the effective Field Of View (FOV). The fixed sensors rely on the stability of the spacecraft (the spacecraft has automated precise pointing capability) and the fact that the spacecraft, by orbiting the Earth, constantly changes its ground target swath. RapidEye is an example of an upcoming constellation that intends to combine high resolution imagery with small satellite technology to provide image data for commercial customers.

The past several years have also seen some developments regarding using the Internet as a way of communicating with satellites as well as using internet protocols for interconnecting onboard instruments. It has proven convenient to use internet protocols and the Internet to send and receive data (through ground stations with antennae) to satellites. These communications have been typically low rate data and require scheduled up and downlinks that may be hours apart for Low Earth Orbiting satellites. These links are also built for and used by specialized scientific user communities (typically government or University laboratories) and are not designed to allow for generalized interactivity as described in this patent specification.

Since the dawn of the space age people all over the world have been keenly interested in the space program. There is a lot of interest the various fields of study that are space related such as astronomy and cosomology, the planets, the Sun, the Moon as well as human activity in space. Ever since the Apollo moon landings which were seen worldwide on television the people of the Earth have watched with great interest and fascination the enormous strides that have been taken with the development of space. There has even been recent activity in developing the capability of sending private citizens into space aboard private and in some cases, government spacecraft. The space programs have over the years always endeavored to capture these activities using both still and video imagery. This is why we had cameras at the Moon landings, on the Space Stations, and even on Mars. There have been a few cameras on board recent rocket launches that captured live video of the launch sequence (Rocketcam by Ecliptic Enterprises). However these cameras were fixed and only recorded a predetermined view. There has also been some recent concepts of using cameras for satellite on-orbit inspection where the camera is fixed to a smaller craft that can travel around the parent spacecraft and provide images, including video, of the parent craft. This would be done on an as needed basis if there was a problem with the spacecraft.

These events and the images of them have not been interactive. The viewers were passive while the operation of the cameras were either manual control by astronauts or automated systems designed to record the image data for a later download to a groundstation. These image capture activities have not generally been available to people outside the immediate space activity related community. There have been some cameras such as the student camera on the International Space Station that can be operated by students on the ground but this has been a still image camera that does not allow for true interactivity.

There have been other proposals for cameras to be placed on board satellites for both Geostationary and Low Earth Orbiting environments. However none of the systems bring true real-time (a few seconds delay), interactivity (direct pointing and zoom control of the camera), low cost (development cost and costs to the user), and availability to anyone with an internet connected computer.

### BRIEF SUMMARY OF THE INVENTION

A summary is provided, herein, to briefly and generally describe the invention by which the objectives presented here and in the section “Background” are addressed. A more detailed description including references to the pertinent drawings is provided in the section “Detailed Description”.

The main objective of the present invention is to provide any user connected to the internet a live and controllable view of the Earth, Earth's near space environment, visible celestial objects, and any objects of interest that are or could be visible from an Earth orbiting vantage point.

The present invention uses one or more video image sensors that are physically based on a Low Earth Orbiting satellite. The image sensors provide a live and realtime video image stream (sequential images that are captured at a rate higher than three frames per second) that is available to be processed and downlinked via an onboard communication system to a remote transceiving station that may be located on the ground, in the air or in space. The live and realtime video image stream would be sent over the internet back to the user who is actively controlling the onboard image sensor via a client computer interface device such as keyboard arrow buttons or mouse cursor control. In order to be an effective realtime experience the total time for a user command to be sent, received by the transceiver and then the satellite image sensors, image sensor movement and return of the subsequent image stream should be less than two seconds.

The video image system is to be, live and in realtime, actively controlled by users through the internet, a remote transceiving station, an onboard communication system, onboard controllers and finally the image sensor's multi-axis actuators that allow for an interactive viewing environment. This invented system, method and apparatus provides for the distribution of the resultant live views and interactive capability across the entire internet infrastructure.

The video image subsystem includes a Charge Coupled Device (CCD) type video image sensor, along with its associated optics, that is integrated to a multi-axis pointing device or mechanism that can physically move the image sensor about any or all three spatial axes. This assembly further includes one or more apparatus', such as integrated shielding, that serve to protect the image assembly from the extreme thermal environment as well as help protect it from space debris impacts and radiation hazards. This integrated video image sensor assembly can include redundant actuators in order to reduce the failure probability. This subsystem also includes the sensor pointing control electronics and image read out electronics as well as any associated interfaces for data handling and electrical power. The image processing electronics and/or software could be integrated either with the subsystem or with satellite bus.

In brief the sequence of events that would comprise a typical user experience would involve the user, sitting at a home or at another computer that is connected to the internet, gaining authorized access to the satellite through a website. The user would receive an initial live image stream from the onboard video image sensor system that has been downlinked to a remote transceiver station and fed into the internet infrastructure. The user could, using the computer's input devices such as the keyboard or mouse, alter the onboard video image sensor pointing direction, depth of focus or light collection ability and receive the subsequent new video image stream within about two seconds. The command signal would be sent to the remote transceiver station via the internet whereby the command is uplinked to the satellite. The commands, once onboard, would then be routed through the computer microprocessor and on to the image sensor controller(s). The controller(s) would then, using the image sensor actuators, cause the view to be altered. The user could make numerous live and real-time observations by repeating this control loop.

### BRIEF DESCRIPTION OF THE SEVERAL VIEWS OF THE DRAWING

The following drawing descriptions when referenced with the associated drawings provide a more complete understanding and general appreciation of the salient features and their advantages of the present invention, wherein:

FIG. 1 INTERACTIVE IMAGE SYSTEM BLOCK DIAGRAM shows a system block diagram illustrating the system components and their functional relationships with each other as well as the general operational flow;

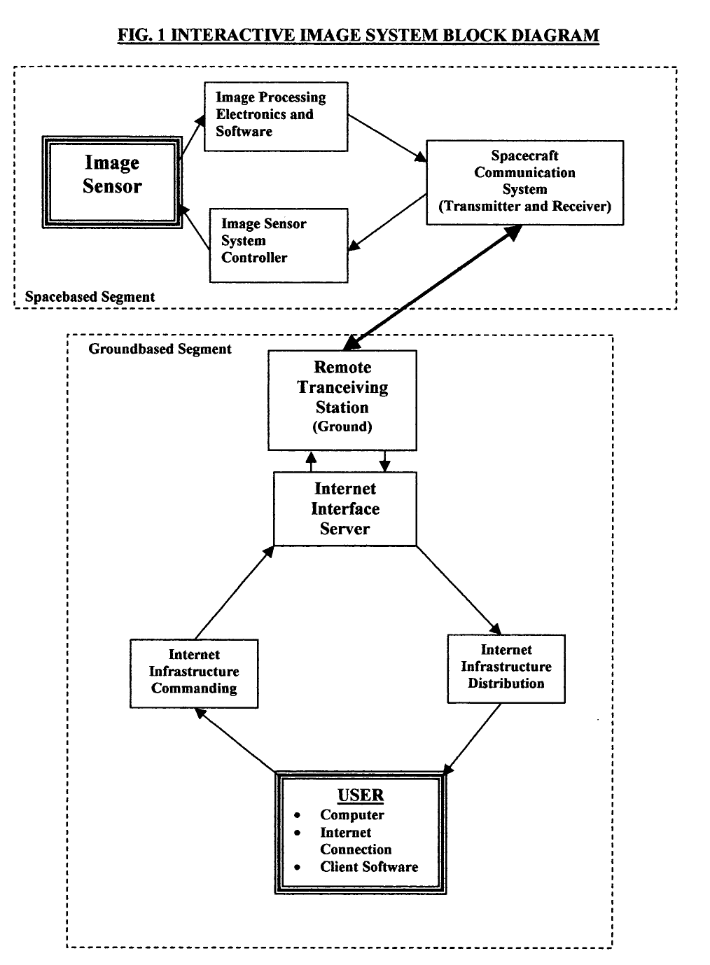

FIG. 2 OVERALL SYSTEM FUNCTIONAL CONCEPT DRAWING is a system concept drawing showing how the main system components are related in operation;

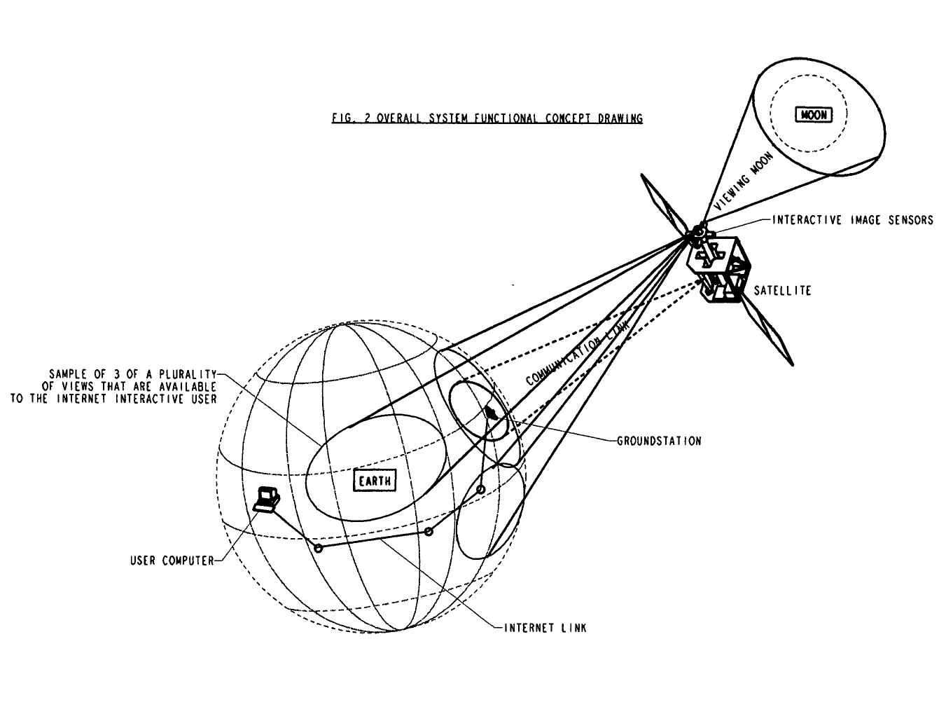

FIG. 3 SATELLITE DRAWING WITH EMBODIMENT OF IMAGE SENSOR PLATFORM shows 3a) a satellite and 3b) the first embodiment of the image sensor system with images sensors on a deployable platform;

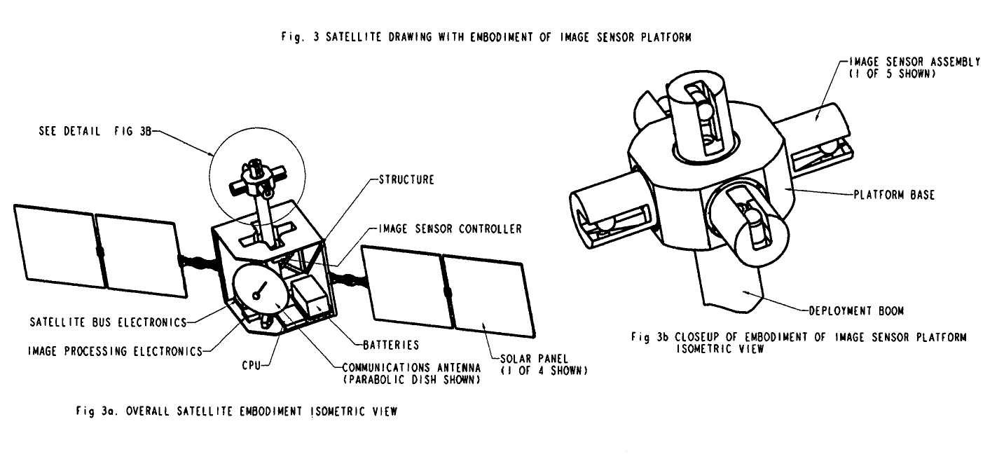

FIG. 4 EMBODIMENT OF IMAGE SENSOR PLATFORM WITH IMAGE SENSOR ASSEMBLY EXPLODED VIEW shows a first embodiment of image sensor platform wherein is an exploded view of one of the image sensor assemblies;

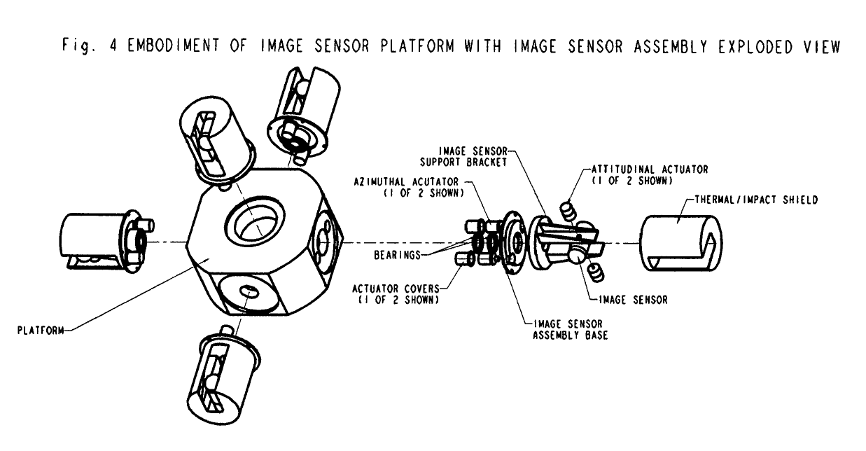

FIG. 5 EMBODIMENTS OF IMAGE SENSOR ASSEMBLY SHOWING AXES OF MOTION FOR CONTROLLING VIEWS shows a first embodiment of an image sensor assembly wherein freedom of movement due to user commands is illustrated;

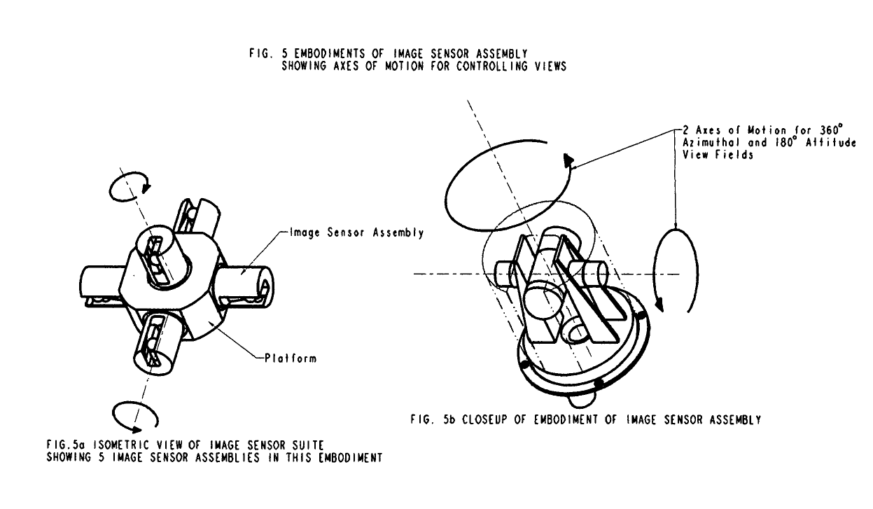

FIG. 6 REMOTE TRANSCEIVER STATION BLOCK DIAGRAM showing the functional relationships between the communications apparatus and the internet infrastructure;

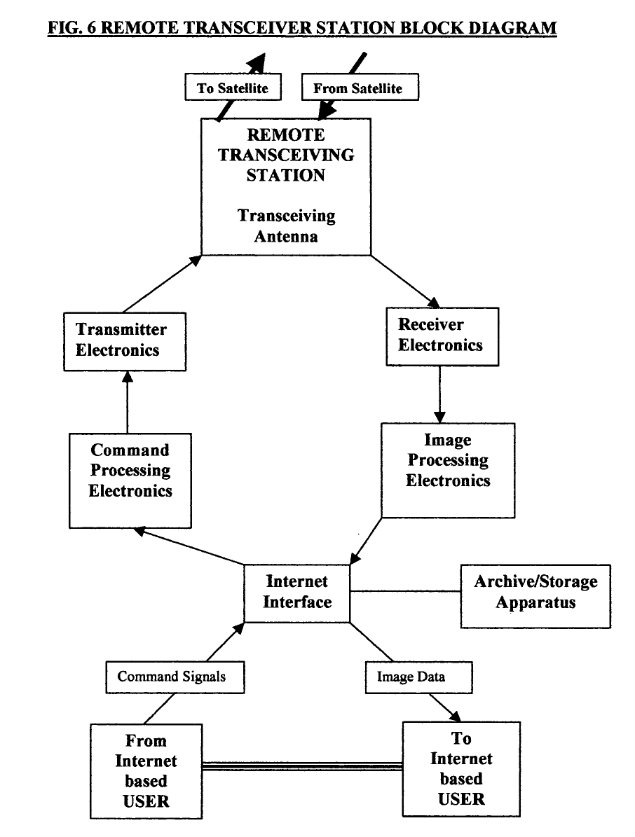

### DETAILED DESCRIPTION OF THE INVENTION

The present invention is a system that comprises several subsystem components that function together to satisfy the main objective. The components include the video image subsystem, the satellite bus, the remote transceiving station, the internet connection and distribution system, and the client or user interface.

The satellite bus subsystem provides the physical structure to which the image subsystem is attached as well as electrical power using either batteries or solar panels. The satellite bus also provides other system resources such as data handling and storage with an onboard computer and associated electronics, stationkeeping including 3 axis stability, position and altitude determination through the Global Positioning System (GPS), and nadir pointing capability of the communication antennae. The satellite bus is designed to provide these system resources in support of the video image system. In order to reduce costs and complexity, the satellite is 3 axis stabilized to to only a few tenths of a degree in order to provide a stable platform for viewing and nadir pointing antenna(e). The individually controlled image sensors reduce the spacecraft control requirements since the only stability requirement is to keep the communication antenna pointing toward the Earth. This greatly reduces cost and complexity of the communication system since the accurate pointing of the antenna(e) will not be necessary. The antenna, either parabolic dish or phased array type, can be a wide beam broadcast type. This has the added advantage of trading antenna pointing and tracking complexity for transmitter power. The wide beam broadcast method also increases the ground track coverage and link on-time for each remote transceiver during each orbit. The downlinked video image stream requires high data rates (even with onboard image processing and compression) whereas the uplinked command signals, regardless of user activity, requires much lower rates. The communication system is designed to downlink at high data rates (greater than 1 Mbps) whereas the uplink data rate is much lower.

The video image subsystem is designed to generate live video images of objects and events that are the chosen subjects of the user. Each image sensor is essentially a digital video camera device that is, or has its sensing elements, mounted to an actuating device. The actuators effectively control the camera position and focusing capability in order to allow the user to either actively point it or alter its zoom or wide field characteristics. Each image sensor subsystem is protected from the thermal and debris field environment by integrated shielding. A second embodiment would include shielding to simultaneously protect more than one image sensor assembly. The video image subsystem generates a digital image stream that is sent to the image processing electronics that, using hardware and/or software techniques, converts the image stream into data that is then downlinked through the communication system to a remote transceiving station.

The overall architecture of this invention also includes one or more remote transceiving stations that are able to both receive downlinked data from the satellite and uplink the commands that ultimately control the image sensors. The advantage of using a transceiving station (as opposed to uplinking via a separate route) is so that the close timing of the interactive control and feedback loop is preserved. The remote transceiving station includes the transmitting and receiving antenna(e), the requisite transmitter and receiver electronics, image processing electronics and software for preparing the image stream for either internet streaming or archiving to a local storage device such as a computer disk, optical or tape drive. The station would also include, or be connected to, a local computer server that would interface with the internet infrastructure. The server would connect to the internet through a high speed data link that allows for high data rate video streaming to internet users. This video image stream, either raw or derivative products, would also be available to a plurality of authorized users for passive viewing.

It should be apparent to those skilled in the art that there are numerous variations on the invention described herein and that would be encompassed by the spirit and scope of this invention as set forth by the claims and description.

1. An imaging system configured to be deployed on a satellite in Low Earth Orbit, comprising:
one or more imaging sensors that are individually configured to be controlled by a pointing mechanism, via electrical signals, through two or three axes of motion namely rotation or translation or depth of field and,
said imaging sensors that produce images sequentially and in temporal frequency at a rate faster than three images per second and,
a controller sub-system that receives commands from the onboard computer and communication system and generates control signals that control actuators that control said image sensors and,
an onboard image processing system wherein the said image data is prepared using, but not limited to, digital imagery compression techniques for transfer to the onboard communication system and,
an onboard communication system that can transmit the image stream to a remote transceiving station that may be located on the ground, in the atmosphere, or in space and,
a remote transceiving station system that is connected directly to the internet and can distribute said downlinked image data throughout the internet infrastructure as well as uplink the said image sensor's control commands.

2. The real-time video imaging system in claim 1 wherein the image sensors are configured on a common platform that is subordinate to the spacecraft structure.

3. The real-time video imaging system in claim 2 wherein said common platform is configured to allow for multiple viewing angles and field of views.

4. The real-time video imaging system in claim 2 wherein said common platform is separately controlled, activated and deployed.

5. The real-time video imaging system in claim 1 wherein said image sensors are mounted directly on spacecraft primary or secondary structure.

6. The real-time video imaging system in claim 1 further comprising one or more redundant drive actuators for each axis of movement.

7. The real-time video imaging system in claim 1 further comprising a mechanism or apparatus for altering said image sensor's depth of focus.

8. The real-time video imaging system in claim 1 wherein the said sequential images creates a video image stream.

9. The real-time video image stream in claim 8 wherein said image stream data is processed and compressed by some factor to reduce image data quantity.

10. The real-time video image stream in claim 8 wherein said image stream is sent to the onboard communication system.

11. The real-time video image stream in claim 8 wherein said image stream is downlinked to a remote transceiving station.

12. The real-time video image stream in claim 8 wherein the image stream is sent to an onboard data storage device.

13. The real-time video image stream in claim 8 wherein the image stream is distributed through the internet infrastructure.

14. The real-time video imaging system in claim 1 further comprising a thermal control apparatus for said image sensor subsystem.

15. The real-time video imaging system in claim 1 further comprising an impact protection apparatus for said image sensor subsystem.

16. The remote transceiving station of claim 1 further comprising
a receiving antenna and,
a receiver and,
a data handling system and,
a local data storage device and,
an internet link and,
a power system and,
a transmitter and,
a transmitting antenna and,
an antenna pointing system.

17. The image sensor of claim 1 further comprising a photon input modifying apparatus.

18. The image sensor photon modifying apparatus of claim 17 wherein said apparatus includes an aperture modulator.
